(19) United States
(12) Patent Application Publication
(10) Pub. No.: US 2019/0239486 A1
(43) Pub. Date: Aug. 8, 2019

(54) BEEHIVE HEATER

(71) Applicant: Kosto Serafimovski, Macomb, MI (US)

(72) Inventor: Kosto Serafimovski, Macomb, MI (US)

(21) Appl. No.: 15/890,926

(22) Filed: Feb. 7, 2018

(51) Int. Cl. A01K 47/06; A01K 1/00

(52) U.S. Cl. CPC A01K 47/06; A01K 1/0076

(57) ABSTRACT

My years of experience working as beekeeper I observed ups and downs with the bees not surviving the winter in cold climate. Between the diseases, moisture, mold and food. The cost to purchase packages of bees every year increase.

Also, the packages you buy are not the same quality as the bees that survive the winter.

By observing the death of the beehive through the winter I came to conclusion to do something about that and I did. Did my homework and searched for beehive heater through beekeeping catalogs and I was unable to locate any.

I started to design the heater several years ago. With My background and expertise in electrical, mechanical and little bit of sketch up knowledge I started my invention.

In my design by providing adequate flow of air and heat the moisture will be eliminated and will prevent the mold to collect in the four corners of the bee box. The heat in the box also will help the bees to move freely from frame to frame to get to the food to survive.

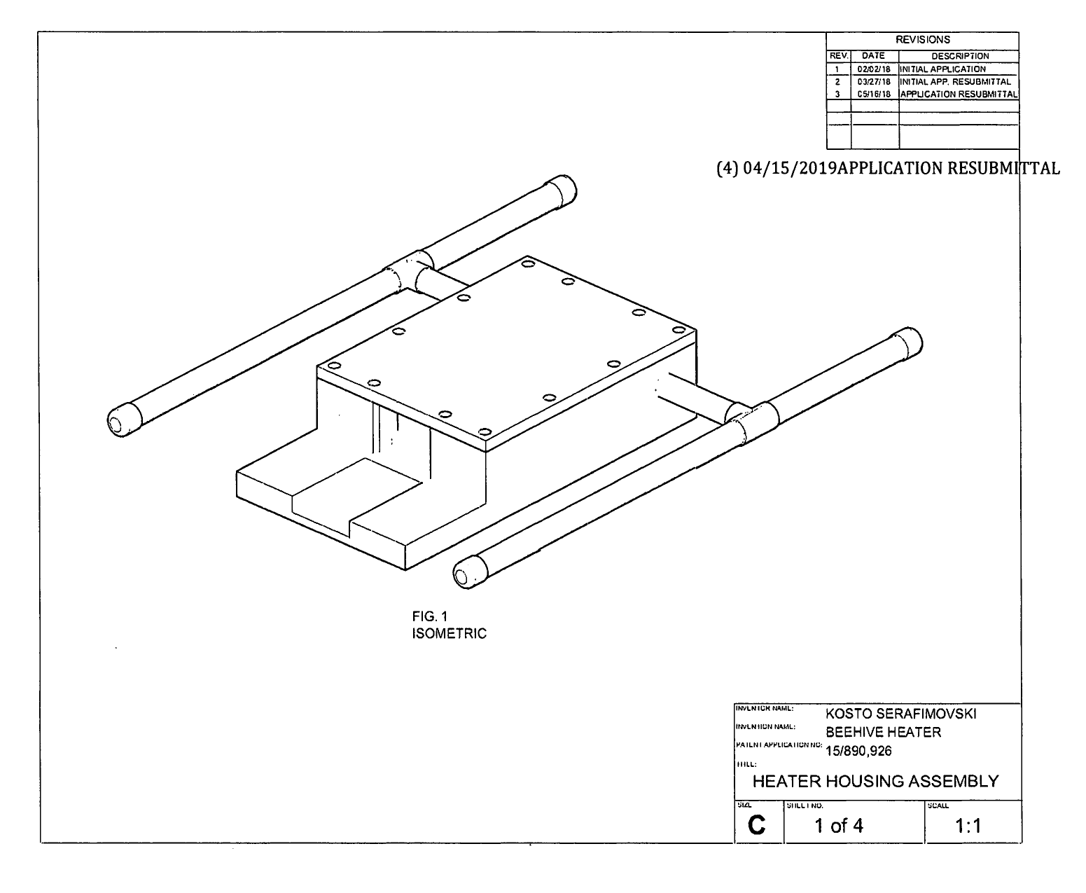

FIG. 1 Bee Hive Heater Assembly shown without fan and the electric heater.

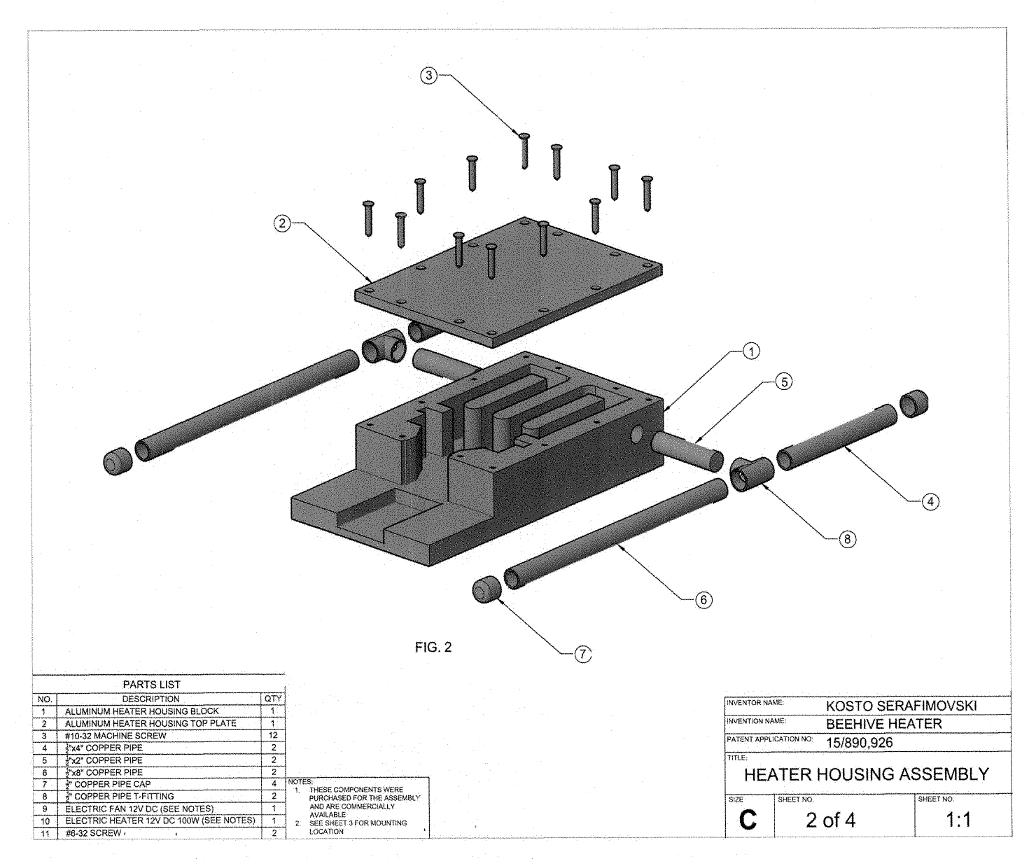

FIG. 2. Heater Housing Assembly show all the components to assemble the unit. Check below description of the components.

FIG. 2. Item 3 quantity of 12 #10-32 Machine screw, secure Top plate item 2 and Bottom plate item 1.

FIG. 2. Two copper tubing, Item 4 dimensions are 4 inches L and 0.5-inch ID.

FIG. 2. Two copper Tubing Item 5 dimensions are 2 inches L and 0.5-inch ID.

FIG. 2. Two copper Tubing Item 6 dimensions are 8 inches L and 0.5-inch ID.

FIG. 2. Two copper Tees Item 8 dimensions are ⅝-inch ID.

FIG. 2. Four copper caps item 7 dimensions are ⅝-inch ID.

Housing (heater and fan housing assembly) Item 1 dimension are 9 L inches by 4¾ W and 1¾ H.

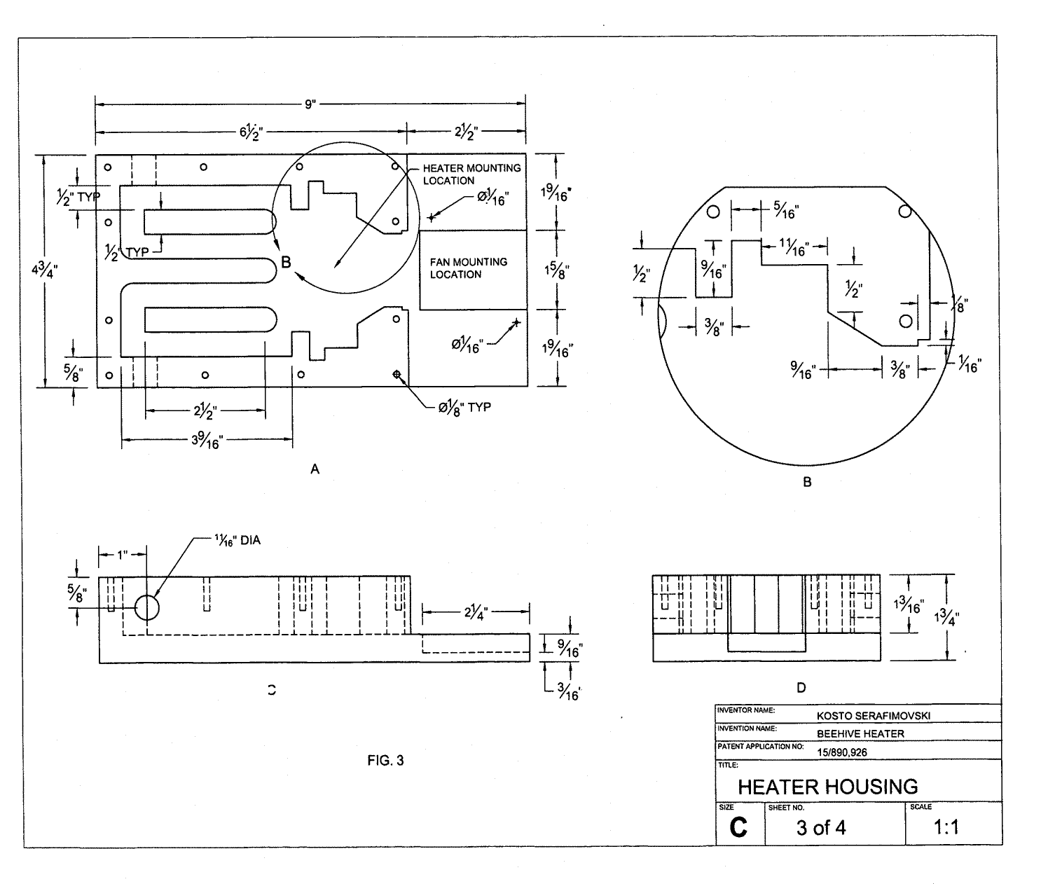

FIG. 3 Provides installation for the heater mounting location A, Fan mounting location B and Side View show two mounting holes for tubing location C.

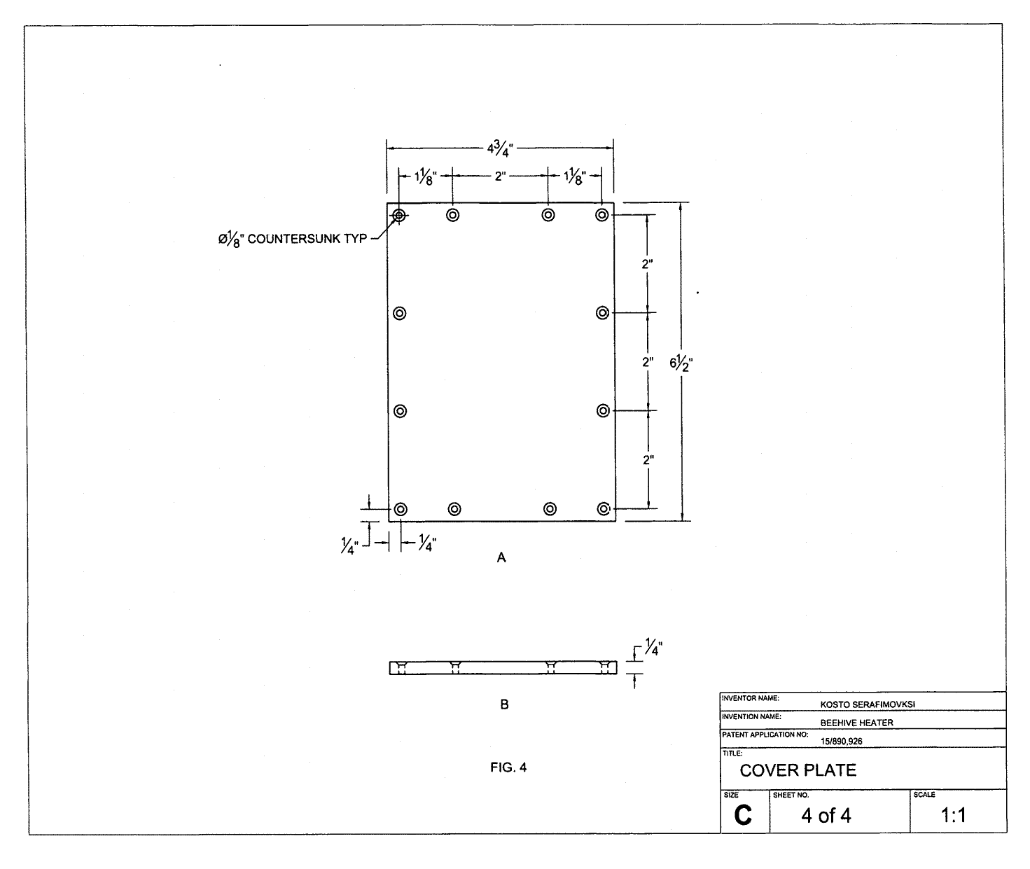

FIG. 4. Show mounting holes location A and thickness of the Top Cover Plate location B

### DISCLOSURE

The Copper caps item 7 also is used to control the flow of the air movement and heat control by making the hole from smaller diameter to large diameter to increases the flow of the air and increases the heat.

Subject to change the Copper cap item 7 from FIG. 2. Top View with electric valve, in the near future. For now, the air movement and heat adjustment it controls with item 7 from FIG. 2.

Currently FIG. 3 C the hole diameter for the tubing is 11/16 DI that diameter can change as needed to larger diameter tubing ¾ or 1″.

Disclosed is a heating system for bee boxes to prevent casualties of bees during the winter. The heating system may include a temperature controller to stabilize an ideal temperature for the bee box. Furthermore, a battery and charger may be utilizing to provide power to heating system. Solar panels may also provide power for the heating system. The prior art devices appear to fail to singly provide you disclosed solar panel and temperature control for bee boxes in combination.

Late in December 2017 and early January 2018 outside Temperature dropped approximately to −16 F for two weeks. After all the work and completing the heaters I have chance to test the heaters. I added the heaters to two boxes of colonies, one colony was small, couple hundred of bees and the other colony approximate last than 2000 bees.

Now in February 2018 both colonies are doing great.

The Beehive heater functions by several power sources like solar power, battery, windmill and in household electricity. If the household electricity is used, need 12 VDC 40 AMP power supply to convert AC to DC, if wind mill or solar power is used, you will not require power supply, for the solar power need battery and solar power charger.

For the windmill depends on the type of wind mill you need.

Fan and heater element should work in sink, if the heater provides higher temperature than the fan, cannot provide the flow of air the heater will burn.

The power for the heater 100 W 12 DC and the Fan 12 DC 0.5 A.

To adjust the temperature read and understand the instructions for the controller that comes with it.

To control the temperature for proper heat, install the thermostat and adjust the temperature as needed. When the heater turns on, after the fan will start and blow the hot air through the tubing connected to the heater. Then the hot air will slowly travel through the opening cap. The output of hot air is directed so the air gets to appropriate place and maintains heat throughout the box.

1. Between the diseases, moisture, mold and food. The cost to purchase packages of bees every year increases. Quality of bees survive through the winter much greater and healthier.
